(19) United States
(12) Patent Application Publication
(10) Pub. No.: US 2010/0194973 A1
(43) Pub. Date: Aug. 5, 2010

(54) Visual presenter

(75) Inventors: Hiroshi Yamakose, Gifu (JP); Shinji Ono, Aichi (JP); Kenichi Maruyama, Aichi (JP)

Correspondence Address: POSZ LAW GROUP, PLC, 12040 SOUTH LAKES DRIVE, SUITE 101, RESTON, VA, 20191, US

(73) Assignee: Elmo Co., Ltd., Nagoya-shi (JP)

(21) Appl. No.: 12/588,418

(22) Filed: Oct. 15, 2009

(30) Foreign Application Priority Data
Jan. 30, 2009 (JP) 2009-019011

(51) Int. Cl. H04N 5/225

(52) U.S. Cl. 348/373; 348/E05.024

(57) ABSTRACT

A visual presenter includes a column support standing on a base, and a camera head mounted on a distal end of the column support. The column support includes an upright part standing from the base and a horizontal part extending horizontally ahead of the base. A pedestal is mounted on a first support shaft mounted on the base, so as to be pivotable in a right-left direction between a standing position and a lying position. The pedestal has an end located opposite the first support side. A second support shaft is located on a pedestal end so as to protrude forward from a base front. The upright part includes a basal portion which is mounted on the second support shaft, so as to be pivotable between a first position where the basal portion stands on the pedestal and a second position where the basal portion stands upright on the pedestal.

### CROSS-REFERENCE TO RELATED APPLICATIONS

This application is based on and claims the benefit of priority from the prior Japanese Patent Application No. 2009-19011, filed on Jan. 30, 2009, the entire contents of which are incorporated herein by reference.

### BACKGROUND

1. Field

The present invention relates to a visual presenter in which a camera head is provided on a distal end of a column support standing on a base, and a material such as document or model placed in front of the base is imaged by the camera head, and an obtained image is reproduced by a monitor television or projected on a screen by a video projector.

2. Related Art

Japanese patent application publication, JP-A-2008-193391 discloses one type of visual presenter. FIGS. 15 and 16 show the disclosed visual presenter 100. As shown, a support column 102 is mounted on a base 101 so as to stand from the base 101. The support column 102 has a distal end on which a camera head 103 is mounted.

The support column 102 of the visual presenter 100 includes an upright part 102a standing upright from the base 101 and a horizontal part 102b that is continuous from the upright part 102a and extends horizontally ahead of the base 101. The camera head 103 is mounted on the distal end of the horizontal part 102b. A material such as document is placed on an installation surface on which the base 101 of the visual presenter 100 is placed, so as to come close to a front of the base 101 and is imaged by an imaging lens 104 of the camera head 103.

In the above-described visual presenter 100, a mounting 200 discrete from the visual presenter 100 is used when a material has a larger size than an imaging area of the camera head 103. In this case, the visual presenter 100 is placed on the mounting 200, and the material is then imaged by the camera head 103. An imaging distance from the imaging lens 104 of the camera head 103 to the material becomes longer when the mounting 200 is used than when the mounting 200 is not used. Accordingly, the imaging area 201 of the camera head 103 can be enlarged.

In the conventional visual presenter 100, however, the imaging area cannot be enlarged without use of the mounting 200 which is discrete from the visual presenter 100 and on which the visual presenter 100 needs to be placed. Thus, the conventional visual presenter 100 is not convenient for users.

Furthermore, when the visual presenter 100 is placed on the mounting 200 so that the imaging area 201 is enlarged, even a front end of the mounting 200 is included in the imaging area 201 as shown in FIG. 16, whereupon the front end of the mounting 200 is imaged by the camera head 103 together with the material. This poses a problem.

### SUMMARY

Therefore, an object of the present invention is to provide a visual presenter which can enlarge the imaging area by a simple operation without use of the mounting operation and has good usability.

Another object of the invention is to provide a visual presenter which can image only the material when the imaging area is enlarged, preventing anything other than the material from being imaged together with the material.

According to one aspect of the present invention, there is provided a visual presenter comprising a base; a column support standing on the base and having a distal end on which a camera head is located, the column support including an upright part standing upright from the base and a horizontal part that is continuous from the upright part and extends horizontally ahead of the base, the distal end of the column support corresponding to a distal end of the horizontal part, the camera head being mounted on the distal end of the horizontal part and adapted to image a material placed on an installation surface for the base; a pedestal mounted on a first support shaft further mounted on the base, so as to be pivotable in a right-left direction between a standing position where the pedestal stands on the base and a lying position where the pedestal lies horizontally relative to the base, the pedestal having an end located opposite the first support side; and a second support shaft provided on the end of the pedestal so as to protrude forward from a front of the base, wherein the upright part includes a basal portion which is mounted on the second support shaft further mounted on the pedestal, so as to be pivotable between a first position where the basal portion stands on the pedestal lying horizontally relative to the base and a second position where the basal portion stands on the pedestal standing on the base.

In the above-described construction, an imaging distance from the camera head to the material on the base installation surface is longer by the spacing between the first and second support shafts when the pedestal stands on the base than when the pedestal lies horizontally relative to the base. Consequently, the imaging area of the camera head can be enlarged.

Moreover, a distance from the camera head to the front of the base is also increased since the second support shaft on which the basal portion of the upright part is to be mounted protrudes ahead of the front of the base. Consequently, the base front can be prevented from being imaged together with the material when the imaging area is enlarged.

In an embodiment, the base is formed with a housing recess in which the pedestal is housed, and the pedestal is housed in the housing recess when assuming the lying position and stands on the housing recess when assuming the standing position. As a result, the visual presenter can be rendered more compact since the pedestal is allowed to lie in the housing recess.

In another embodiment, the housing recess is a notch formed in either one of right and left corners of a front edge of the base. Consequently, the visual presenter can further be rendered more compact since the pedestal is allowed to lie down and is housed in the notch formed in the corner of the base.

In further another embodiment, the horizontal part is mounted on a third support shaft further mounted on upright part, so as to be pivotable to a position where the horizontal part is juxtaposed to the upright part, and the upright part is mounted on the second support shaft further mounted on the pedestal, so as to be pivotable from the pedestal lying in the housing recess to a first juxtaposed position where the upright part is juxtaposed to a front of the base. In this construction, the pedestal is allowed to lie in the notch and the upright part is allowed to pivot from the lying pedestal to the position where the pedestal is juxtaposed to the front of the base. Furthermore, the horizontal part is allowed to pivot to the position where the horizontal part is juxtaposed to the upright part. Consequently, the visual presenter can be folded into a compact form.

In further another embodiment, the base, the pedestal, the upright part and the horizontal part have upper surfaces and undersides respectively; the horizontal part is pivotable from the pedestal lying in the housing recess to a second juxtaposed position where the horizontal part is juxtaposed to the upright part assuming the first juxtaposed position; and the upper surfaces of the base, the pedestal lying in the recess, the upright part assuming the juxtaposed position and the horizontal part assuming the second juxtaposed position all are substantially coplanar, and concurrently, the undersides of the base, the pedestal, the upright part and the horizontal part are substantially coplanar. In this construction, when the visual presenter has been folded, the upper surfaces of the pedestal, the upright and horizontal parts are coplanar, and the undersides of the pedestal, the upright and horizontal parts are also coplanar. Consequently, the visual presenter can further be folded into a more compact form.

According to another aspect of the present invention, there is provided a visual presenter comprising a base; a column support standing on the base and having a distal end on which a camera head is located, the column support including an upright part standing on the base and a horizontal part that is continuous from the upright part and extends horizontally ahead of the base, the distal end of the column support corresponding to a distal end of the horizontal part, the camera head being mounted on the distal end of the horizontal part and adapted to image a material placed on an installation surface for the base; a pedestal mounted on a first support shaft further mounted on the base, so as to be pivotable in a front-back direction between a standing position where the pedestal stands on the base and a lying position where the pedestal lies horizontally relative to the base, the pedestal having an end located opposite the first support side; and a second support shaft provided on the end of the pedestal so as to protrude forward from a front of the base, wherein the upright part includes a basal portion which is mounted on the second support shaft further mounted on the pedestal, so as to be pivotable between a first position where the basal portion stands on the pedestal lying horizontally relative to the base and a second position where the basal portion stands on the pedestal further standing on the base.

In the above-described construction, too, an imaging distance from the camera head to the material on the base installation surface is longer by the spacing between the first and second support shafts when the pedestal stands on the base than when the pedestal lies horizontally relative to the base. Consequently, the imaging area of the camera head can be enlarged.

Moreover, a distance from the camera head to the front of the base is also increased when the pedestal is caused to pivot ahead of the base thereby to stand up. Consequently, the base front can be prevented from being imaged together with the material when the imaging area is enlarged.

In the above-described construction, the base may also be formed with a housing recess in which the pedestal is housed, and the pedestal may be housed in the housing recess when assuming the lying position and stands on the housing recess when assuming the standing position. As a result, the visual presenter can be rendered more compact since the pedestal is allowed to lie in the housing recess.

Furthermore, the housing recess may be a notch formed in a central part of the base. Consequently, the visual presenter can further be rendered more compact.

Additionally, the horizontal part may be mounted on a third support shaft further mounted on upright part, so as to be pivotable to a position where the horizontal part is juxtaposed to the upright part, and the upright part may be mounted on the second support shaft further mounted on the pedestal, so as to be pivotable from the pedestal lying in the housing recess to a position where the upright part extends horizontally ahead and back of the base. In this construction, the pedestal is allowed to lie in the notch and the upright part is allowed to pivot from the lying pedestal to the position where the pedestal is juxtaposed to the front of the base. Furthermore, the horizontal part is allowed to pivot to the position where the horizontal part is juxtaposed to the upright part. Consequently, the visual presenter can be folded into a compact form.

### BRIEF DESCRIPTION OF THE DRAWINGS

FIG. 1 is a perspective view of a visual presenter in accordance with one embodiment of the present invention, in which view a pedestal stands;

FIG. 2 is a perspective view of the visual presenter, in which view the pedestal lies down;

FIG. 3 is a perspective view of the visual presenter which is folded;

FIG. 4 is a side view of the visual presenter in the case where the pedestal is laid down;

FIG. 5 is a plan view of the visual presenter in the case where the pedestal is laid down;

FIG. 6 is a side view of the visual presenter in the case where the pedestal stands;

FIG. 7 is a plan view of the visual presenter in the case where the pedestal stands; p FIG. 8 is a perspective view of a visual presenter in accordance with a second embodiment of the present invention, in which view a pedestal stands;

FIG. 9 is a perspective view of the visual presenter in the case where the pedestal is laid down;

FIG. 10 is a side view of the visual presenter in the case where the pedestal stands;

FIG. 11 is a plan view of the visual presenter in the case where the pedestal stands;

FIG. 12 is a side view of the visual presenter in the case where the pedestal is laid down;

FIG. 13 is a plan view of the visual presenter in the case where the pedestal is laid down;

FIG. 14 is a perspective view of the visual presenter in the folded state;

FIG. 15 is a perspective view of a conventional visual presenter; and

FIG. 16 is a side view of the conventional visual presenter.

### DETAILED DESCRIPTION

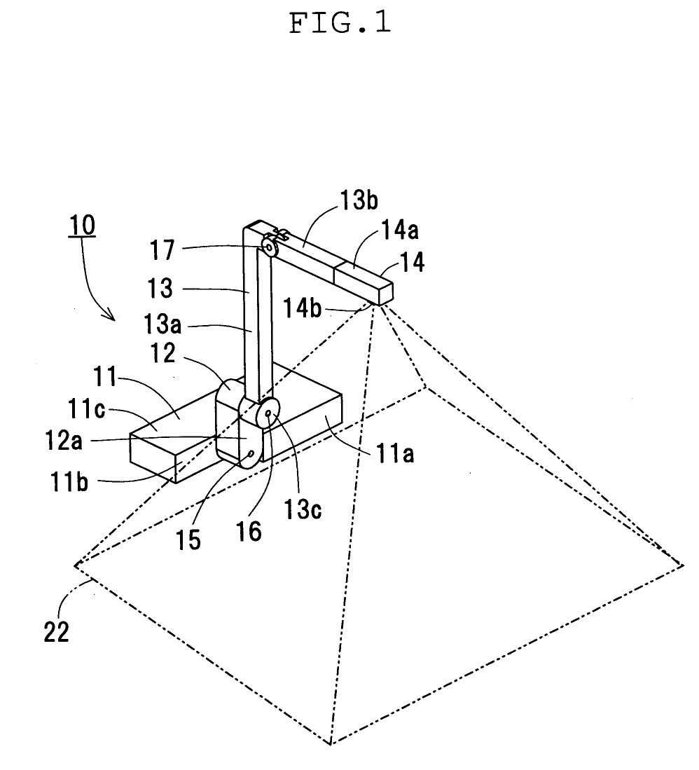

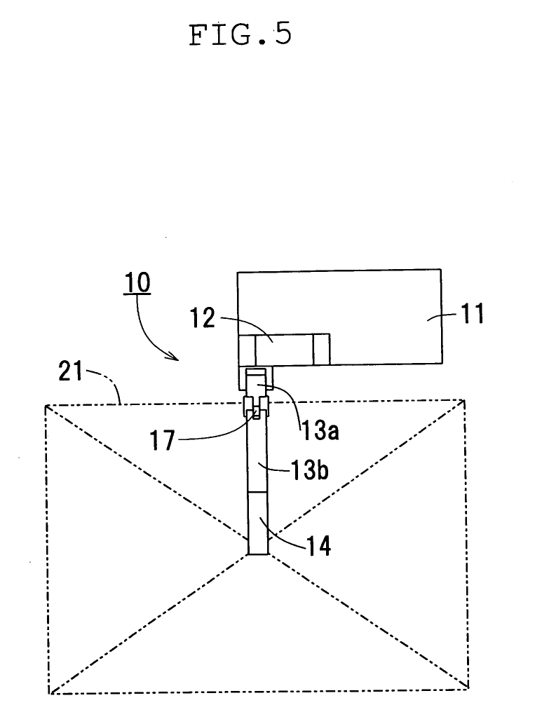

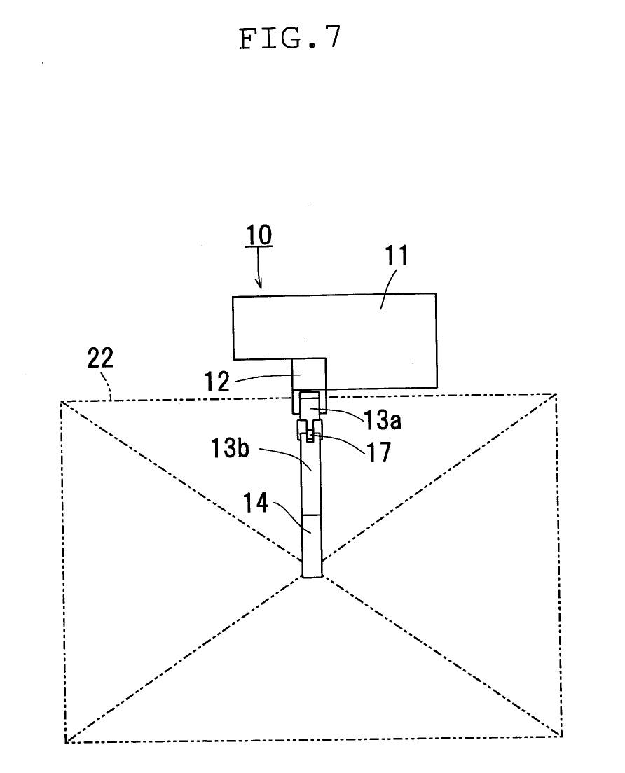

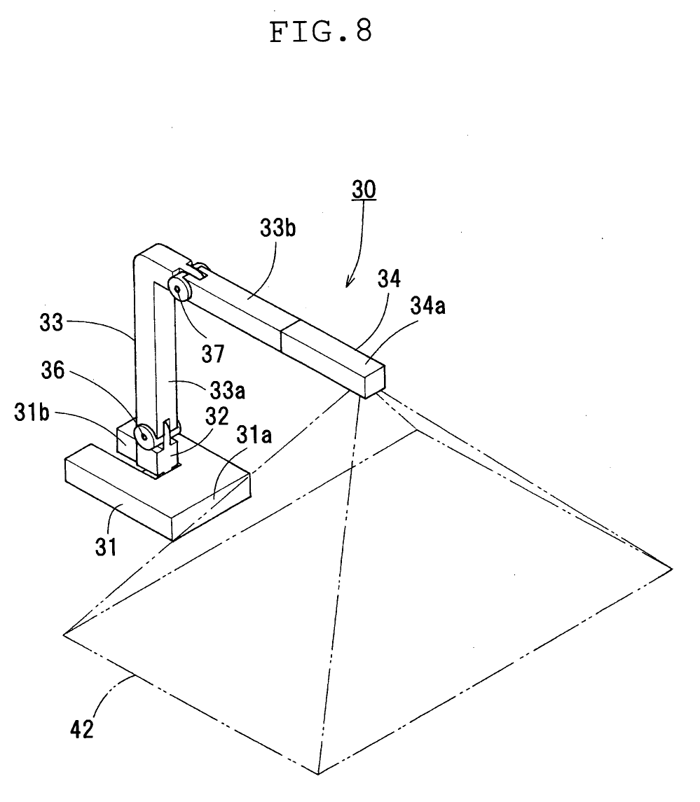

A first embodiment of the present invention will be described with reference to FIGS. 1 to 7 of the accompanying drawings. Referring to FIG. 1, a visual presenter of the embodiment is shown. The visual presenter 10 includes a base 11, a pedestal 12, a support column 13 and a camera head 14. The base 11 is generally rectangular in planar shape and includes a front 11a having a left corner in which a notch 11b serving as a housing recess is formed. The pedestal 12 is housed in the notch 11b. A control circuit unit (not shown) is incorporated in the base 11. The base 11 has a rear (not shown) provided with terminals which are used to connect the visual presenter 10 to a TV monitor, a video projector 10 and the like.

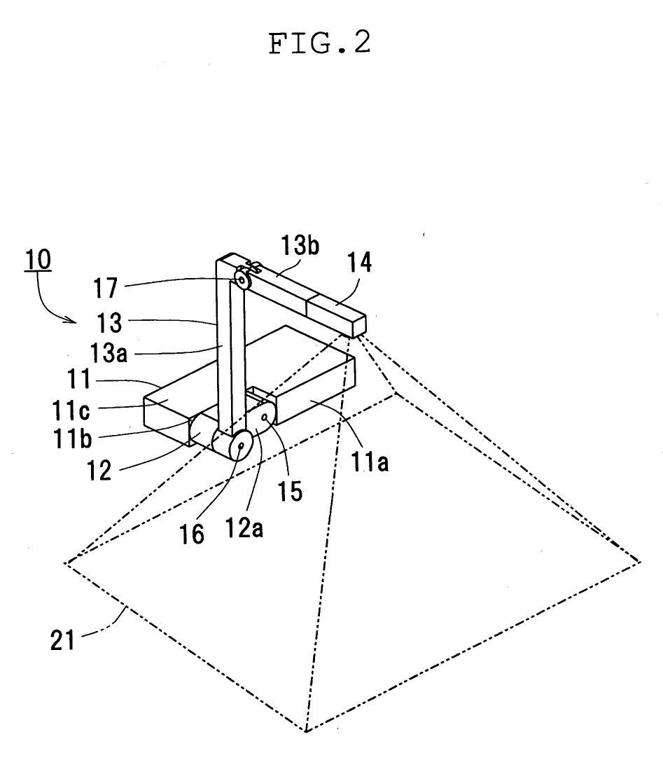

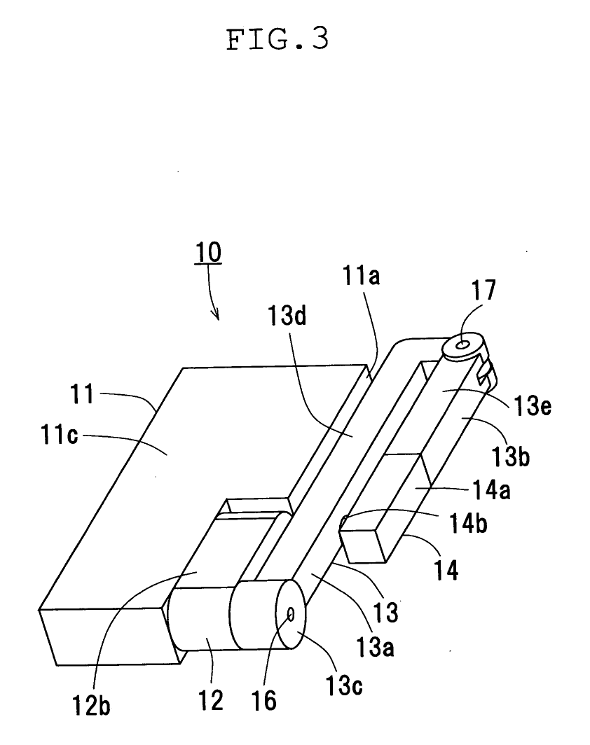

The pedestal 12 is mounted on a support shaft 15 further mounted on a front corner of the base 11, so as to be pivotable in a right-left direction between a standing position where the pedestal 12 stands on the notch 11b of the base 11 as shown in FIG. 1 and a lying position where the pedestal 12 lies relative to the notch 11b as shown in FIGS. 2 and 3. The support column 13 has a hollow construction and is composed of an upright part 13a and a horizontal part 13b extending ahead of the base 11 horizontally from an upper end of the upright part 13a. Wire harnesses (not shown) are inserted through the support column 13 to connect between the control circuit unit incorporated in the base 11 and the camera head 14.

The upright part 13a of the support column 13 is mounted on a second support shaft 16 further mounted on an end of the pedestal 12 opposite the first support shaft 15. The second support shaft 16 protrudes ahead of the front 11a of the base 11 from the front end surface 12a of the pedestal 12. The upright part 13a includes a base portion 13c which is mounted on the second support shaft 16 further mounted on the pedestal 12, so as to be located immediately before the front 11a of the base 11 and protrude ahead of the front 11a. The upright part 13a is mounted on the second support shaft 16 further mounted on the pedestal 12, so as to be pivotable among a first standing position where the upright part 13a stands on the pedestal 12 further standing on the notch 11b as shown in FIG. 1, a second standing position where the upright part 13a stands on the pedestal 12 lying relative to the pedestal 12 as shown in FIG. 2 and a juxtaposed position where the upright part 13a extends from the pedestal 12 lying relative to the notch 11b so as to be juxtaposed to the front 11a of the base 11 as shown in FIG. 3.

The horizontal part 13b is mounted on a third support shaft 17 further mounted on an upper end of the upright part 13, so as to be pivotable between a horizontal position where the horizontal part 13b extends ahead of the base 11 horizontally so as to be perpendicular to the upright part 13b as shown in FIGS. 1 and 2 and a juxtaposed position where the horizontal part 13b is juxtaposed to the upright part 13a as shown in FIG. 3.

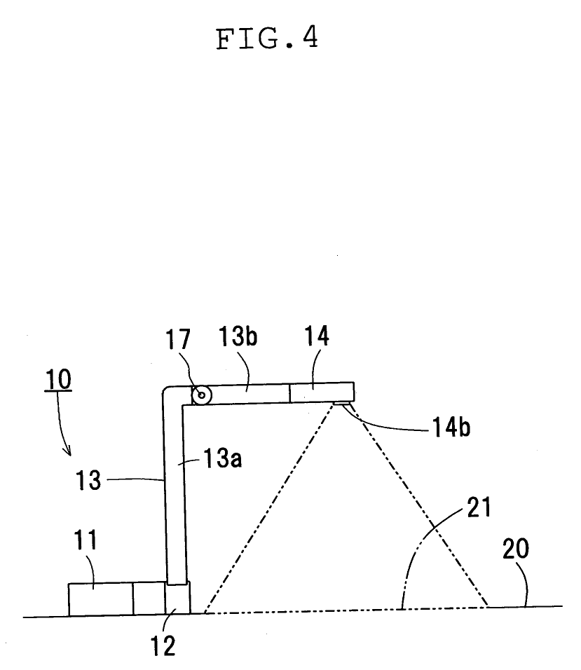

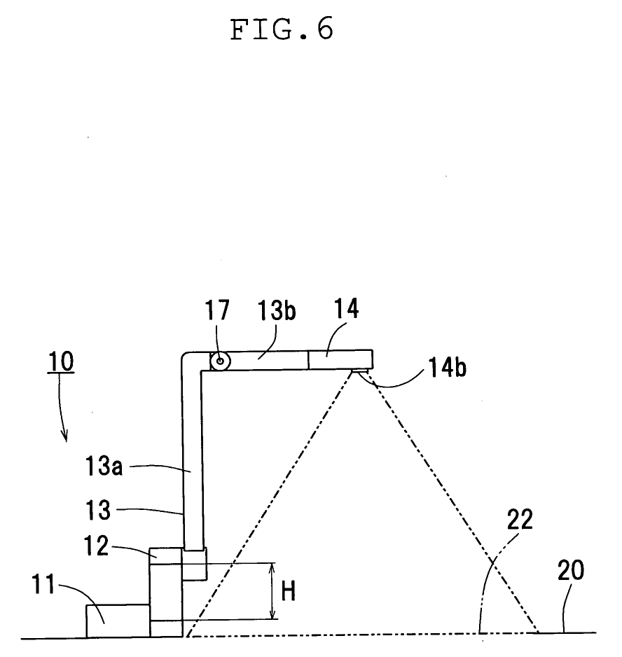

The camera head 14 has a generally rectangular parallelepiped housing 14a which is fixed to a front end of the horizontal part 13c so as to align linearly with the horizontal part 13b and extends forward. A lens tube 14b (see FIGS. 4 and 6) into which an imaging lens group is built protrudes downward from a lower surface of the front end of the housing 14a. A camera control circuit (not shown) is incorporated in the housing 14a. A balancer (not shown) with a predetermined weight is provided in the base 11 in order that the visual presenter 10 may be prevented from falling ahead of the base 11 by the weight of the camera head 14.

A usage of the visual presenter 10 as constructed above will now be described as follows. Firstly, the upright part 13a of the support column 13 is caused to stand on the pedestal 12 lying relative to the notch 11b, and the horizontal part 13b is caused to extend horizontally ahead of the base 11, as shown in FIGS. 2, 4 and 5. A material is then placed on the base installation surface 20 (see FIG. 4), and the position of the material is adjusted so as to be fit into the imaging area 21.

In the case where the size of the material is so large that the entire material cannot be imaged even when a field angle of the imaging lens is set to a widest angle, the pedestal 12 is caused to stand on the notch 11b, and the upright part 13a is caused to stand on the pedestal 12, as shown in FIGS. 1, 6 and 7. As the result of this operation, the distance between the base installation surface 20 and the imaging lens set to the widest angle is increased by the spacing H between the first and second support shafts 16 and 17, whereby the imaging area 22 can be enlarged.

When the visual presenter 10 is not used, the pedestal 12 is caused to lie relative to the notch 11b, and the upright part 13a of the support column 13 is juxtaposed to the front 11a of the base 11. Furthermore, the horizontal part 13b is juxtaposed to the upright part 13a, whereupon the visual presenter 10 can be folded into a compact form. The visual presenter 10 is dimensioned so that the upper surface 11c of the base 11, the upper surface 12b of the pedestal 12, the upper surface 13d of the upright part 13a and the upper surface 13e of the horizontal part 13b are all substantially coplanar when the visual presenter 10 is folded as shown in FIG. 3. Furthermore, at the same time, the visual presenter 10 is dimensioned so that the undersides of the base 11, the pedestal 12, the upright part 13a and the horizontal part 13b are substantially coplanar. In this case, the pedestal 12 lies relative to the notch 11b. The upright part 13a is caused to pivot to the position where the upright part 13a is juxtaposed to the front 11a of the base 11 from the pedestal 12 lying relative to the notch 11b. The horizontal part 13b is caused to pivot to the position where the horizontal part 13b is juxtaposed to the upright part 13a having been caused to pivot to the position where the upright part 13a is juxtaposed to the front 11a of the base 11 from the pedestal 12 lying relative to the notch 11c.

According to the foregoing embodiment, an imaging distance from the camera head 14 to the material on the base installation surface 20 is longer by the spacing H between the first and second support shafts 15 and 16 when the pedestal 12 stands on the notch 11b of the base 11 than when the pedestal 12 lies relative to the notch 11b. Consequently, the imaging area 22 can be enlarged by causing the pedestal to stand.

Moreover, the second support shaft 16 on which the basal portion 13c of the upright part 13a is mounted protrudes from the front 11a of the base 11. Consequently, the distance of the imaging lens of the camera head 14 from the front 11a of the base 11 can also be increased, whereupon the base front 11a can be prevented from being imaged together with the material when the imaging area 22 is enlarged.

Furthermore, when the visual presenter 10 has been folded, the upper surfaces 12b, 13d and 13e of the pedestal 12, the upright part 13a and the horizontal part 13b and the upper surface 11c of the base 11 are all substantially coplanar, and the undersides of the pedestal 12, the upright part 13a and the horizontal part 13b and the underside of the base 11 are all substantially coplanar. Consequently, the visual presenter 10 can be folded into a further more compact form.

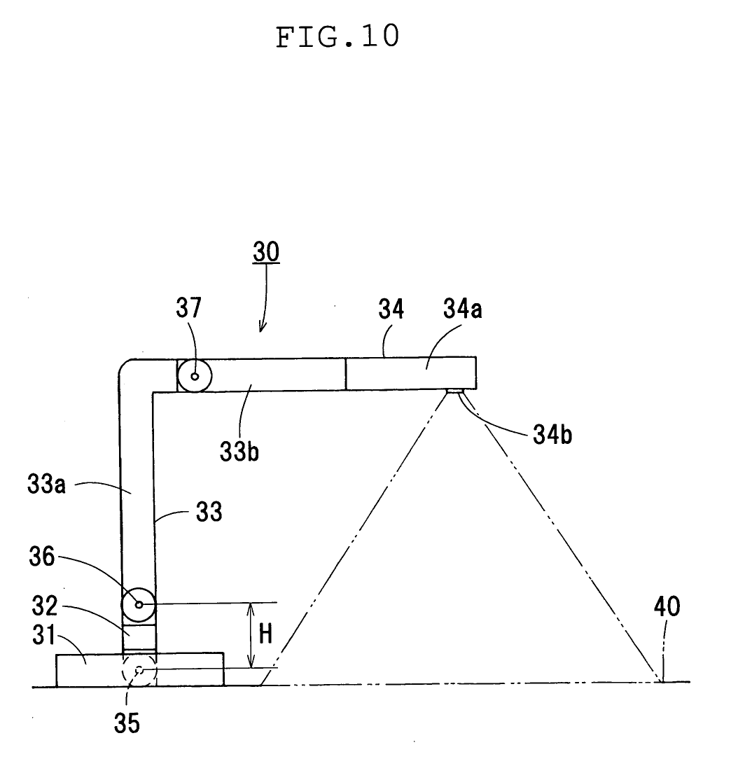

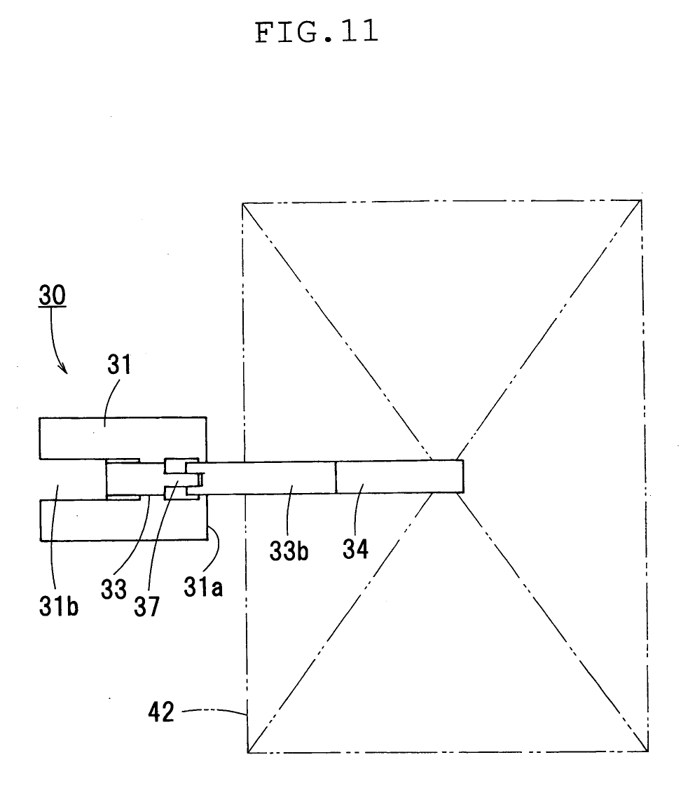

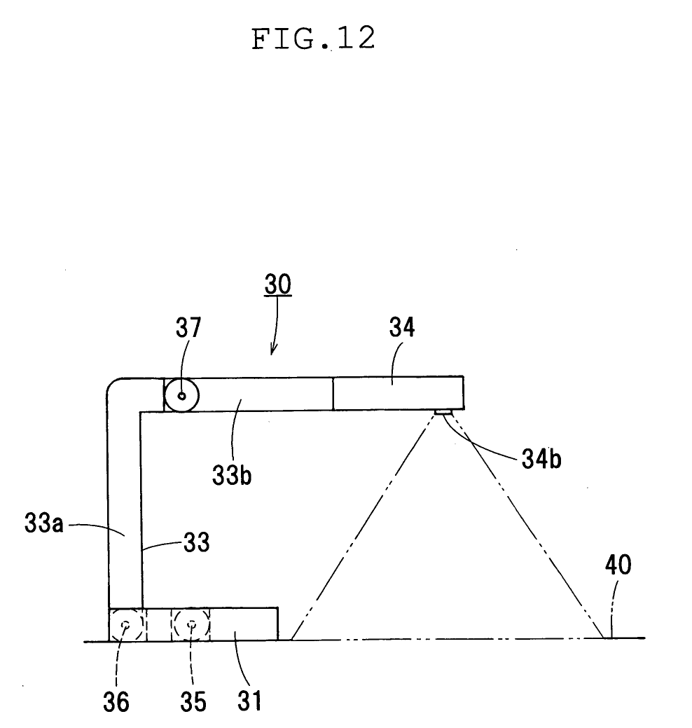

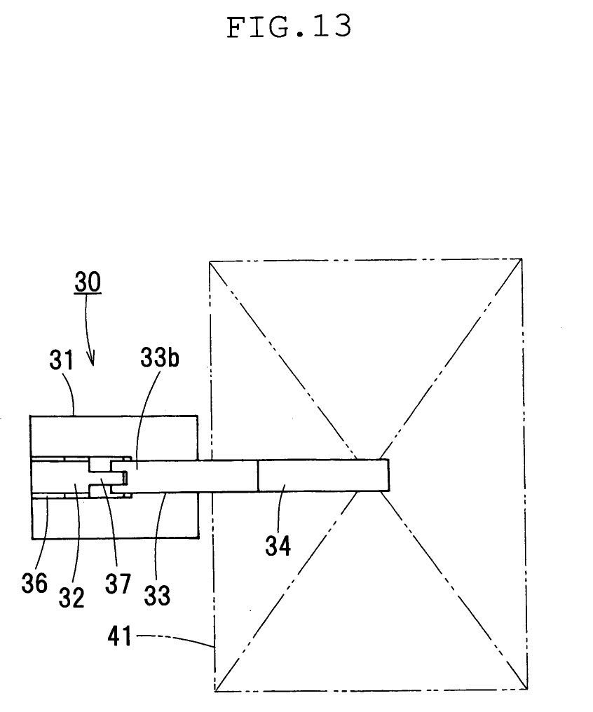

FIGS. 8 to 13 illustrate a second embodiment. The visual presenter 30 includes a base 31, a pedestal 32, a support column 33 and a camera head 34. The base 31 is generally rectangular in planar shape and includes a notch 31b which is formed in a central part thereof and serves as a housing recess for housing the pedestal 32. The notch 31b extends to a rear surface of the base 31.

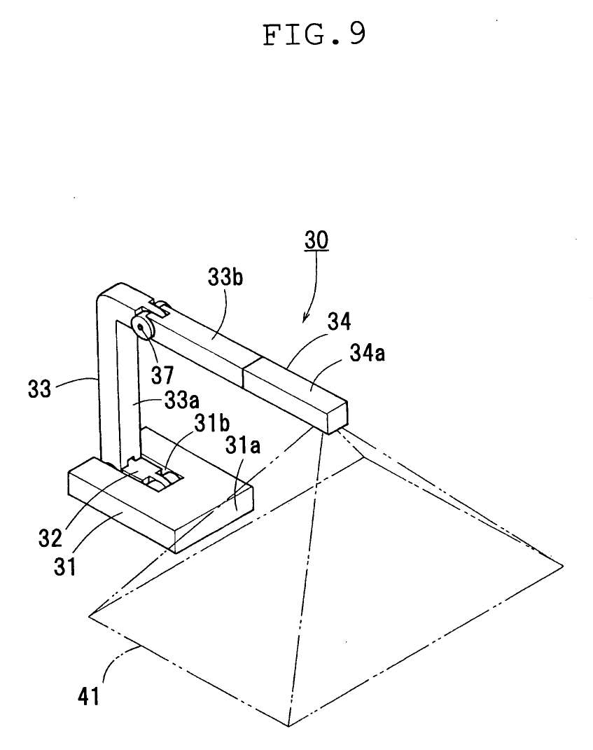

The pedestal 32 is mounted on a first support shaft 35 further mounted on a central portion of the base 31, so as to be pivotable in a front-back direction between a standing position where the pedestal 32 stands on the notch 31b of the base 31 as shown in FIGS. 8, 10 and 11 and a lying position where the pedestal 32 lies relative to the notch 31b as shown in FIGS. 9, 12 and 13. The support column 33 is composed of an upright part 33a and a horizontal part 33b extending ahead of the base 31 horizontally from an upper end of the upright part 33a.

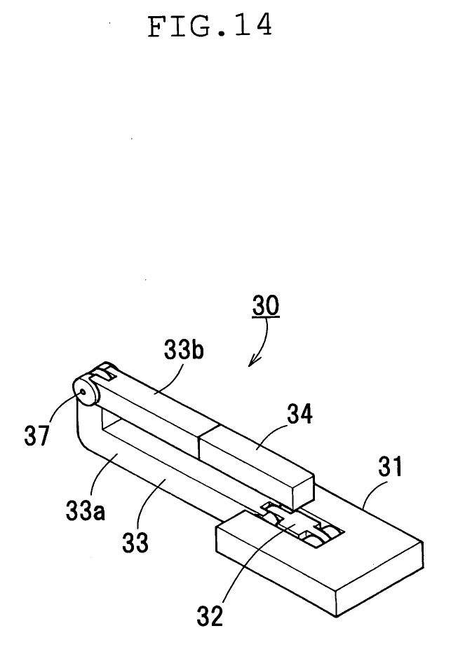

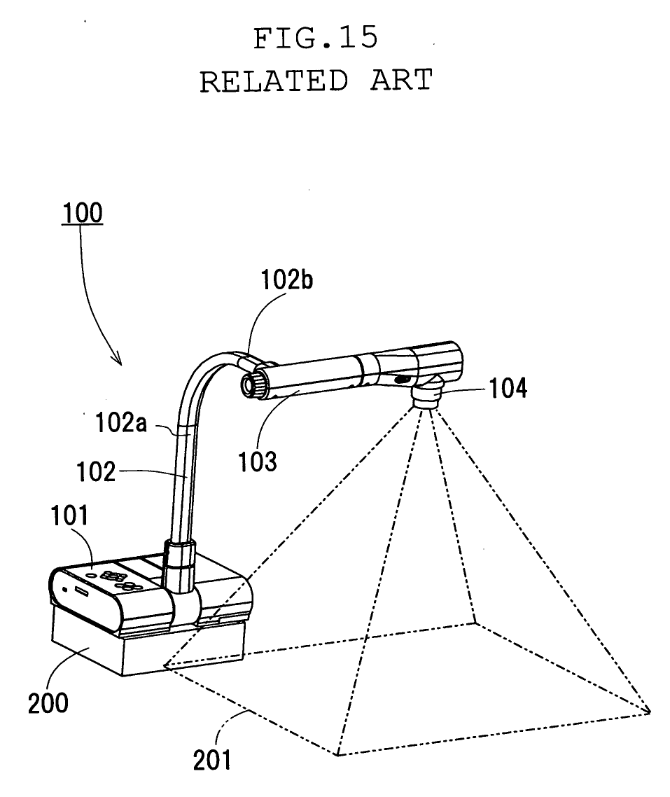

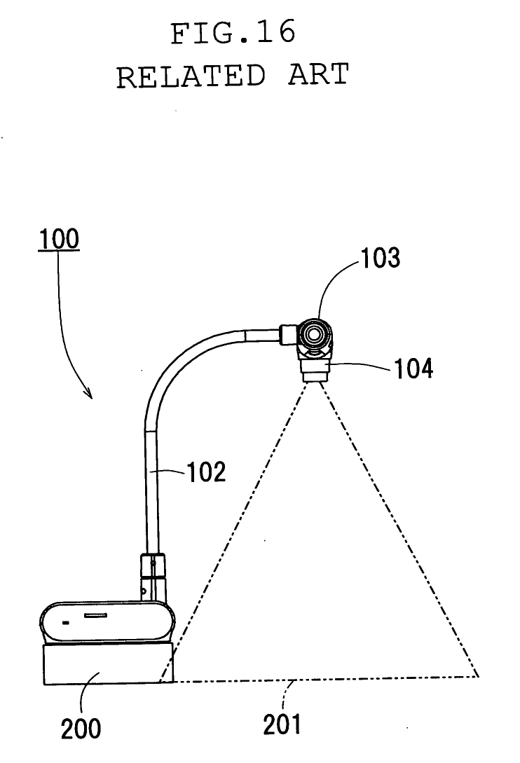

The upright part 33a of the support column 33 is mounted on a second support shaft 36 further mounted on an end of the pedestal 32 opposite the first support shaft 35. The upright part 33a is mounted on the second support shaft 36 further mounted on the pedestal 32, so as to be pivotable in the front-back direction among a first standing position where the upright part 33a stands on the pedestal 32 further standing on the notch 31b as shown in FIGS. 8, 10 and 11, a second standing position where the upright part 33a stands on the pedestal 32 lying relative to the pedestal 32 as shown in FIGS. 9, 12 and 13, and a horizontal position where the upright part 33a extends horizontally from the pedestal 32 lying relative to the notch 31b as shown in FIG. 14.

The horizontal part 33b is mounted on a third support shaft 37 further mounted on an upper end of the upright part 33a, so as to be pivotable between a horizontal position where the horizontal part 33b extends ahead of the base 31 horizontally so as to be perpendicular to the upright part 33b as shown in FIGS. 8 to 13 and a juxtaposed position where the horizontal part 33b is juxtaposed to the upright part 13a as shown in FIG. 14.

The camera head 34 has a generally rectangular parallelepiped housing 34a which is fixed to a front end of the horizontal part 33b so as to align linearly with the horizontal part 33b and extends forward. A lens tube 34b into which an imaging lens group is built protrudes downward from a lower surface of the front end of the housing 34a.

A usage of the visual presenter 10 as constructed above will now be described as follows. Firstly, the upright part 33a of the support column 33 is caused to stand on the pedestal 32 lying relative to the notch 31b, and the horizontal part 33b is caused to extend horizontally ahead of the base 31, as shown in FIGS. 9, 12 and 13. A material is then placed on the base installation surface 40, and the position of the material is adjusted so as to be fit into the imaging area 41.

In the case where the size of the material is so large that the entire material cannot be imaged even when a field angle of the imaging lens is set to a widest angle, the pedestal 32 is caused to stand on the notch 31b, and the upright part 33a is caused to stand on the pedestal 32, as shown in FIGS. 8, 10 and 11. As the result of this operation, the distance between the base installation surface 40 and the imaging lens set to the widest angle is increased by the spacing H between the first and second support shafts 35 and 36, whereby the imaging area 42 can be enlarged.

When the visual presenter 10 is not used, the pedestal 32 is caused to lie relative to the notch 31b, and the upright part 33a of the support column 33 is juxtaposed to the front 31a of the base 31 as shown in FIG. 14. Furthermore, the horizontal part 33b is folded so as to be juxtaposed to the upright part 33a.

According to the foregoing embodiment, an imaging distance from the camera head 34 to the material on the base installation surface 40 is longer by the spacing H between the first and second support shafts 35 and 36 when the pedestal 32 stands on the notch 31b of the base 31 than when the pedestal 32 lies relative to the base 31. Consequently, the imaging area 22 can be enlarged by causing the pedestal 32 to stand. Furthermore, since the pedestal 32 is caused to pivot ahead of the base 31 and to stand, the distance of the imaging lens of the camera head 34 from the front 31a of the base 31 can also be increased, whereupon the base front 31a can be prevented from being imaged together with the material when the imaging area 42 is enlarged.

The foregoing description and drawings are merely illustrative of the principles and are not to be construed in a limiting sense. Various changes and modifications will become apparent to those of ordinary skill in the art. All such changes and modifications are seen to fall within the scope as defined by the appended claims.

What is claimed is:

1. A visual presenter comprising:
a base;
a column support standing on the base and having a distal end on which a camera head is located, the column support including an upright part standing upright from the base and a horizontal part that is continuous from the upright part and extends horizontally ahead of the base, the distal end of the column support corresponding to a distal end of the horizontal part, the camera head being mounted on the distal end of the horizontal part and adapted to image a material placed on an installation surface for the base;
a pedestal mounted on a first support shaft further mounted on the base, so as to be pivotable in a right-left direction between a standing position where the pedestal stands on the base and a lying position where the pedestal lies horizontally relative to the base, the pedestal having an end located opposite the first support side; and
a second support shaft provided on the end of the pedestal so as to protrude forward from a front of the base,
wherein the upright part includes a basal portion which is mounted on the second support shaft further mounted on ₜhe pedestal, so as to be pivotable between a first position where the basal portion stands on the pedestal lying horizontally relative to the base and a second position where the basal portion stands on the pedestal standing on the base.

2. The visual presenter according to claim 1, wherein the base is formed with a housing recess in which the pedestal is housed, and the pedestal is housed in the housing recess when assuming the lying position and rises from the housing recess when assuming the standing position.

3. The visual presenter according to claim 2, wherein the housing recess is a notch formed in either one of right and left corners of a front edge of the base.

4. The visual presenter according to claim 3, wherein the horizontal part is mounted on a third support shaft further mounted on upright part, so as to be pivotable to a position where the horizontal part is juxtaposed to the upright part, and the upright part is mounted on the second support shaft further mounted on the pedestal, so as to be pivotable from the pedestal lying in the housing recess to a first juxtaposed position where the upright part is juxtaposed to a front of the base.

5. The visual presenter according to claim 4, wherein:
the base, the pedestal, the upright part and the horizontal part have upper surfaces and undersides respectively;
the horizontal part is pivotable from the pedestal lying in the housing recess to a second juxtaposed position where the horizontal part is juxtaposed to the upright part assuming the first juxtaposed position; and
the upper surfaces of the base, the pedestal lying in the recess, the upright part assuming the juxtaposed position and the horizontal part assuming the second juxtaposed position all are substantially coplanar, and concurrently, the undersides of the base, the pedestal, the upright part and the horizontal part are substantially coplanar.

6. A visual presenter comprising:
a base;
a column support standing on the base and having a distal end on which a camera head is located, the column support including an upright part standing upright from the base and a horizontal part that is continuous from the upright part and extends horizontally ahead of the base, the distal end of the column support corresponding to a distal end of the horizontal part, the camera head being mounted on the distal end of the horizontal part and adapted to image a material placed on an installation surface for the base;
a pedestal mounted on a first support shaft further mounted on the base, so as to be pivotable in a front-back direction between a standing position where the pedestal stands on the base and a lying position where the pedestal lies horizontally relative to the base, the pedestal having an end located opposite the first support side; and
a second support shaft provided on the end of the pedestal so as to protrude forward from a front of the base,
wherein the upright part includes a basal portion which is mounted on the second support shaft further mounted on the pedestal, so as to be pivotable between a first position where the basal portion stands on the pedestal lying horizontally relative to the base and a second position where the basal portion stands upright on the pedestal standing on the base.

7. The visual presenter according to claim 6, wherein the base is formed with a housing recess in which the pedestal is housed, and the pedestal is housed in the housing recess when assuming the lying position and rises from the housing recess when assuming the standing position.

8. The visual presenter according to claim 7, wherein the housing recess is a notch formed in a central part of the base.

9. The visual presenter according to claim 8, wherein the horizontal part is mounted on a third support shaft further mounted on upright part, so as to be pivotable to a position where the horizontal part is juxtaposed to the upright part, and the upright part is mounted on the second support shaft further mounted on the pedestal, so as to be pivotable from the pedestal lying in the housing recess to a position where the upright part extends horizontally ahead and back of the base.
